(19) United States
(12) Patent Application Publication
(10) Pub. No.: US 2019/0235293 A1
(43) Pub. Date: Aug. 1, 2019

(54) LIQUID CRYSTAL DISPLAY PANEL AND LIQUID CRYSTAL DISPLAY DEVICE

(71) Applicant: Huizhou China Star Optoelectronics Technology Co., Ltd., Huizhou (CN)

(72) Inventor: Chun-chi CHEN, Huizhou (CN)

(73) Assignee: Huizhou China Star Optoelectronics Technology Co., Ltd., Huizhou (CN)

(21) Appl. No.: 16/094,206

(22) PCT Filed: Feb. 27, 2018
(86) PCT No.: PCT/CN2018/077385

§ 371 Date: Oct. 17, 2018

(30) Foreign Application Priority Data
Jan. 26, 2018 (CN) 201810075752.2

(51) Int. Cl. G02F 1/1347; G02F 1/1335

(52) U.S. Cl. CPC G02F 1/1347; G02F 1/134363; G02F 2001/133531; G02F 1/133528

(57) ABSTRACT

The present disclosure provides a liquid crystal display panel and a liquid crystal display device. The liquid crystal display panel includes a first polarizer, a first liquid crystal cell in an in-plane switching (IPS) mode, and a second polarizer sequentially stacked on one another. The liquid crystal display panel further comprises a second liquid crystal cell disposed between the first liquid crystal cell and the second polarizer. At the dark state, the second liquid crystal cell blocks a light leaking from the first liquid crystal cell.

### FIELD OF INVENTION

The present disclosure relates to the field of display technology, and more particularly to a liquid crystal display panel and a liquid crystal display device.

### BACKGROUND

Liquid crystal cells are an essential element of liquid crystal displays (LCDs), where display quality of LCDs is mainly affected by liquid crystal cells. Contrast is one of the important parameters of liquid crystal cells. The higher the contrast is, the more clear and vivid the displayed image is. The lower the contrast is, the darker and more blurred the displayed image is.

Contrast is represented by a ratio of bright-state brightness to dark-state brightness of the display under darkroom condition. Contrast can be increased by either increasing the bright-state brightness or lowering the dark-state brightness. Lowering the dark-state brightness is the direction toward which manufacturers mainly aim to improve contrast.

Based on different rotation fashions of liquid crystal molecules, LCDs have a variety of display modes, and specifically can be classified to include twist nematic (TN), vertical alignment (VA), in-plane switching (IPS) modes. The IPS display mode is characterized in controlling rotation of liquid crystal molecules in a plane to realize image display, and makes displays have wide viewing angles, high transmittance, and thus is widely used.

However, in the IPS mode, due to the materials used for alignment layer, there is a pre-tilt angle for liquid crystal molecules. Presence of the pre-tilt angle leads to the result that, at the dark state, the polarized light which passes through a lower polarizer would generate portion of the light in the direction of the transmission axis of the liquid crystal molecules, causing light leakage at the dark state and low contrast of the displays.

### SUMMARY OF DISCLOSURE

The present disclosure is aimed to provide a liquid crystal display panel and a liquid crystal display device, where contrast of the liquid crystal display device is increased.

In one aspect, the present disclosure provides a liquid crystal display panel, comprising: a first polarizer, a first liquid crystal cell in an in-plane switching (IPS) mode, and a second polarizer sequentially stacked on one another;
wherein the liquid crystal display panel further comprises a second liquid crystal cell disposed between the first liquid crystal cell and the second polarizer;
wherein the first polarizer, the first liquid crystal cell, the second liquid crystal cell, and the second polarizer are configured for carrying out display of a dark state or a bright state; and
wherein, at the dark state, the second liquid crystal cell blocks a light leaking from the first liquid crystal cell.

In some embodiments, the second liquid crystal cell is a liquid crystal cell in an IPS mode.

In some embodiments, an angle between an axial direction of a plurality of liquid crystal molecules in the second liquid crystal cell and an absorption axis of the second polarizer ranges from 85 degrees to 95 degrees, or the angle between the axial direction of the liquid crystal molecules in the second liquid crystal cell and the absorption axis of the second polarizer ranges from −5 degrees to 5 degrees.

In some embodiments, the second liquid crystal cell is a liquid crystal cell in a vertical alignment (VA) mode.

In some embodiments, an angle between an axial direction of a plurality of liquid crystal molecules in the second liquid crystal cell and an absorption axis of the second polarizer ranges from 40 degrees to 50 degrees.

In some embodiments, the liquid crystal display panel further comprises a third polarizer, and the third polarizer is disposed between the first liquid crystal cell and the second liquid crystal cell.

In some embodiments, an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees; and
an angle between the absorption axis of the third polarizer and the absorption axis of the second polarizer ranges from 85 degrees to 95 degrees.

In some embodiments, the liquid crystal display panel further comprises a fourth polarizer, and the fourth polarizer is disposed between the third polarizer and the second liquid crystal cell.

In some embodiments, an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees;
an angle between the absorption axis of the third polarizer and an absorption axis of the fourth polarizer ranges from −5 degrees to 5 degrees; and
an angle between the absorption axis of the fourth polarizer and the absorption axis of the second polarizer ranges from 85 degrees to 95 degrees.

In another aspect, the present disclosure provides a liquid crystal display device, comprising: a liquid crystal display panel and a backlight source;
wherein the liquid crystal display panel comprises a first polarizer, a first liquid crystal cell in an in-plane switching (IPS) mode, a second liquid crystal cell, and a second polarizer sequentially stacked on one another;
wherein a plurality of lights provided by the backlight source passes through the first polarizer, the first liquid crystal cell, the second liquid crystal cell, and the second polarizer in succession to carry out display of a dark state or a bright state; and
wherein, at the dark state, the second liquid crystal cell blocks at least one of the lights leaking from the first liquid crystal cell.

In some embodiments, the second liquid crystal cell is a liquid crystal cell in an IPS mode.

In some embodiments, an angle between an axial direction of a plurality of liquid crystal molecules in the second liquid crystal cell and an absorption axis of the second polarizer ranges from 85 degrees to 95 degrees, or the angle between the axial direction of the liquid crystal molecules in the second liquid crystal cell and the absorption axis of the second polarizer ranges from −5 degrees to 5 degrees.

In some embodiments, the liquid crystal display panel further comprises a third polarizer, and the third polarizer is disposed between the first liquid crystal cell and the second liquid crystal cell.

In some embodiments, an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees; and
an angle between the absorption axis of the third polarizer and the absorption axis of the second polarizer ranges from 85 degrees to 95 degrees.

In some embodiments, the liquid crystal display panel further comprises a fourth polarizer, and the fourth polarizer is disposed between the third polarizer and the second liquid crystal cell.

In some embodiments, an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees;
an angle between the absorption axis of the third polarizer and an absorption axis of the fourth polarizer ranges from −5 degrees to 5 degrees; and
an angle between the absorption axis of the fourth polarizer and the absorption axis of the second polarizer ranges from 85 degrees to 95 degrees.

The present disclosure provides a liquid crystal display panel and a liquid crystal display device. Since a second liquid crystal cell is disposed below the first liquid crystal cell, the light leaking from the first liquid crystal cell can be efficiently blocked at the dark state, and thus contrast is increased.

To explain in detail the above summarized description of the subject invention, preferred embodiments are provided in conjunction with the drawings below.

### BRIEF DESCRIPTION OF DRAWINGS

FIG. 1 is a schematic diagram showing a first structure of a liquid crystal display panel according to one embodiment of the present disclosure.

FIG. 2 is a schematic diagram showing a second structure of a liquid crystal display panel according to another embodiment of the present disclosure.

FIG. 3 is a schematic diagram illustrating light leakage values of the liquid crystal display panel according to one embodiment of the present disclosure and light leakage values of the conventional liquid crystal display panel.

FIG. 4 is a schematic diagram illustrating contrast of the liquid crystal display panel according to one embodiment of the present disclosure and contrast of the conventional liquid crystal display panel.

FIG. 5 is a schematic diagram illustrating light leakage values of the liquid crystal display panel according to another embodiment of the present disclosure and light leakage values of the conventional liquid crystal display panel.

FIG. 6 is a schematic diagram showing a structure of a liquid crystal display device according to one embodiment of the present disclosure.

### DETAILED DESCRIPTION

The following embodiments refer to the accompanying drawings for exemplifying specific implementable embodiments of the present disclosure. Moreover, directional terms described by the present disclosure, such as upper, lower, front, back, left, right, inner, outer, side, etc., are only directions by referring to the accompanying drawings, and thus the used directional terms are used to describe and understand the present disclosure, but the present disclosure is not limited thereto.

In the drawings, the same reference symbol represents the same or similar components.

Reference in the specification to “one embodiment” or “an embodiment” means that a particular feature, structure, or characteristic described in conjunction with the embodiment can be included in at least one embodiment of the invention. The appearances of the phrase “in one embodiment” in various places in the specification do not necessarily all refer to the same embodiment, nor an independent or unique embodiment that is incompatible with other embodiments. It should be appreciated by any person having ordinary skill in the art that any embodiment referred in the specification can combine with other embodiment in the specification.

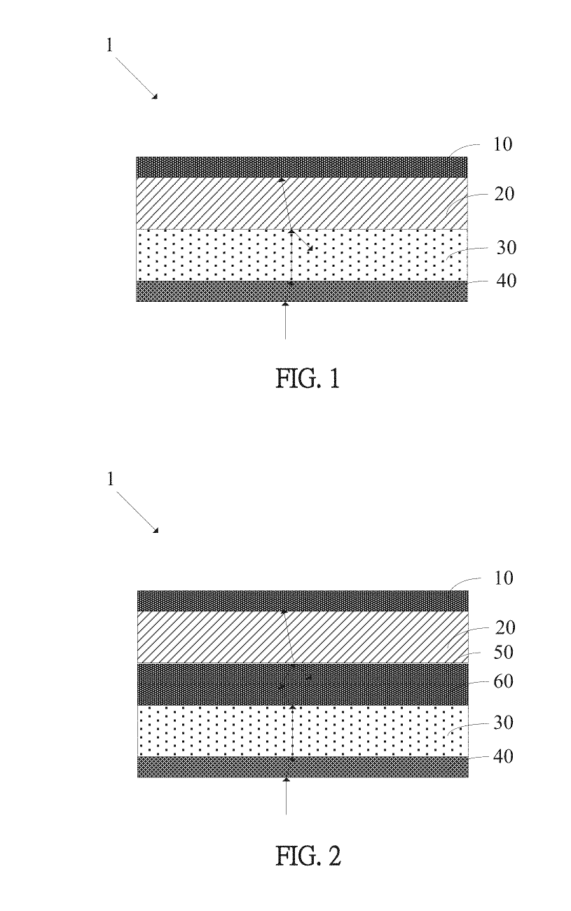

Please refer to FIG. 1, which is a schematic diagram showing a structure of a liquid crystal display panel according to one embodiment of the present disclosure. The liquid crystal display panel 1 includes a first polarizer 10, a first liquid crystal cell 20 in an in-plane switching (IPS) mode, a second polarizer 30, and a second polarizer 40 sequentially stacked on one another.

The first polarizer 10 and the second polarizer 40 are disposed perpendicularly to each other, in order to have the lights vibrating along a certain direction pass therethrough while have other lights vibrating along other directions being blocked. A direction that permits the light to pass through the polarizer refers to a transmission axis of the polarizer, and a direction that blocks the light refers to an absorption axis of the polarizer.

The first liquid crystal cell 20 is an in-plane switching (IPS) liquid crystal cell. In other words, the liquid crystal molecules in the first liquid crystal cell are controlled to rotate in a plane to realize image display. The first liquid crystal cell 20 includes an upper substrate and a lower substrate. The upper substrate is a pixel electrode ITO film, and the upper substrate is a metal electrode. The liquid crystal molecules are parallel to each other and are evenly distributed between the two substrate, and are tilted with an angle with respect to the electrode of lower substrate. In the first liquid crystal cell 20 in an IPS mode, a pair of electrodes are formed on the same substrate for controlling rotation of the liquid crystal molecules. A lateral electric field generated by this pair of electrodes is used to control state of the liquid crystal molecules and makes the liquid crystal molecules twist in a plane that is parallel to the substrate. The direction of the director and the direction of the polarizer are the same, therefore the liquid crystal display panel 1 is at a dark state when there is no electric field.

At the dark state, portion of the light in the direction of the transmission axis of the liquid crystal molecules in the first liquid crystal cell 20 exists, causing light leakage. Therefore, in the present embodiment, a second liquid crystal cell 30 is disposed below the first liquid crystal cell 20, and is used to block the light leaking from the first liquid crystal cell 20 at the dark state. By reducing light leakage of the liquid crystal display panel 1 at the dark state, the dark-state brightness is lowered. This increases contrast of the liquid crystal display panel 1.

On the basis of the embodiment described above, the second liquid crystal cell 30 could be an in-plane switching (IPS) liquid crystal cell, as shown in FIG. 2. In accordance with different practical conditions, an angle between an axial direction of a plurality of liquid crystal molecules in the second liquid crystal cell 30 and an absorption axis of the second polarizer 40 can be set to be within a range to increase light leakage blocking efficiency of the second liquid crystal cell 30.

Preferably, an angle between an axial direction of a plurality of liquid crystal molecules in the second liquid crystal cell 30 and an absorption axis of the second polarizer 40 ranges from 85 degrees to 95 degrees, or the angle between the axial direction of the liquid crystal molecules in the second liquid crystal cell 30 and the absorption axis of the second polarizer 40 ranges from −5 degrees to 5 degrees, such that the light leaking from the first liquid crystal cell 20 can be efficiently blocked.

In some embodiments, the liquid crystal display panel 1 further includes a third polarizer 50. The third polarizer 50 is disposed between the first liquid crystal cell 20 and the second liquid crystal cell 30. The third polarizer 50 and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or an angle between the axial direction of the liquid crystal molecules in the first liquid crystal cell 20 and the absorption axis of the third polarizer 50 ranges from −5 degrees to 5 degrees; and an angle between the absorption axis of the third polarizer 50 and the absorption axis of the second polarizer 40 ranges from 85 degrees to 95 degrees, such that the light leaking from the first liquid crystal cell 20 can be efficiently blocked.

In some embodiments, the liquid crystal display panel 1 further includes a fourth polarizer 60. The fourth polarizer 60 is disposed between the third polarizer 50 and the second liquid crystal cell 30. The fourth polarizer 60, the third polarizer 50, and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the forth polarizer 60, and an angle between the absorption axis of the fourth polarizer 60 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from −5 degrees to 5 degrees; an angle between the absorption axis of the third polarizer 50 and the absorption axis of the forth polarizer 60 ranges from −5 degrees to 5 degrees; and an angle between the absorption axis of the fourth polarizer 60 and the absorption axis of the second polarizer 40 ranges from 85 degrees to 95 degrees, such that the light leaking from the first liquid crystal cell 20 can be efficiently blocked.

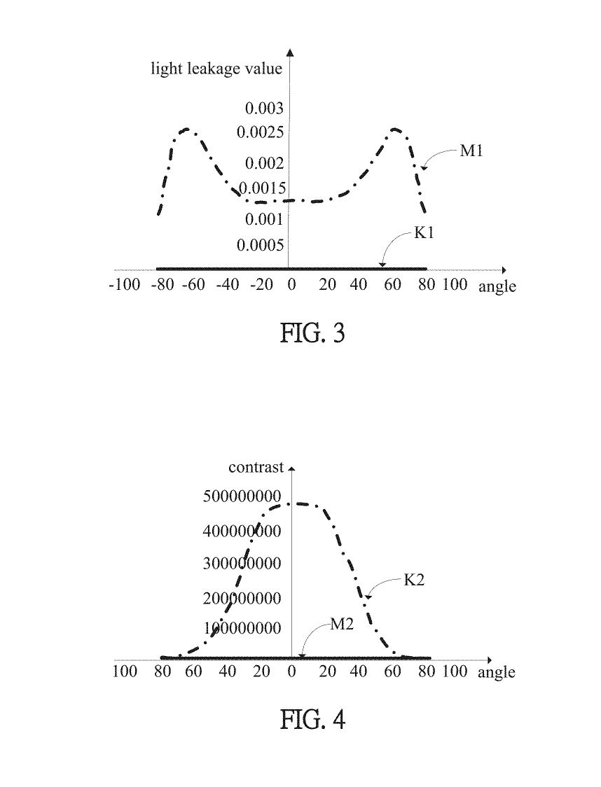

Please refer to FIG. 3, where the dash dotted line M1 shows variations of light leakage values of the conventional liquid crystal display panel, and the solid line K1 shows variations of light leakage values of the liquid crystal display panel 1 of the present embodiment. It is clear that, for the dash dotted line M1, the light leakage values of the conventional liquid crystal display panel gradually increase at the angle in the range from 0 to 60 degrees and in the range from −60 to 0 degrees, and the light leakage values of the conventional liquid crystal display panel gradually decrease at the angle in the range from 60 to 80 degrees. It is also clear that, for the solid line K1, the light leakage values of the liquid crystal display panel 1 of the present embodiment approach zero. In other words, according to the subject invention, the light leaking from the liquid crystal display panel at the dark state can be efficiently blocked. As can be further seen in FIG. 4, the solid line M2 shows variations of contrast of the conventional liquid crystal display panel, and the dash dotted line K2 shows variations of contrast of the liquid crystal display panel 1 of the present embodiment. With comparison between the lines M2 and K2, contrast of the liquid crystal display panel of the present embodiment is far higher than contrast of the conventional liquid crystal display panel. In practical operations, it is found that contrast of the liquid crystal display panel of the present embodiment is nearly 20000 times higher than contrast of the conventional liquid crystal display panel when the display is viewed at a central angle, and contrast of the liquid crystal display panel of the present embodiment is 20000-2000 times higher than contrast of the conventional liquid crystal display panel when the display is viewed at a side angle.

Furthermore, in some embodiments as shown in FIG. 2, the second liquid crystal cell 30 could be a liquid crystal cell in a vertical alignment (VA) mode, where rotation of liquid crystal molecules in the vertical direction is controlled to realize image display. The second liquid crystal cell 30 includes a liquid crystal layer, an upper substrate, and a lower substrate. The liquid crystal molecules in the second liquid crystal cell 30 are parallel to the upper and lower substrates.

In accordance with different practical conditions, an angle between an axial direction of a plurality of liquid crystal molecules in the second liquid crystal cell 30 and an absorption axis of the second polarizer 40 can be set to be within a range to increase light leakage blocking efficiency of the second liquid crystal cell 30. Preferably, an angle between an axial direction of a plurality of liquid crystal molecules in the second liquid crystal cell 30 and an absorption axis of the second polarizer 40 ranges from 40 to 50 degrees, such that the light leaking from the first liquid crystal cell 20 can be efficiently blocked.

In some embodiments, the liquid crystal display panel 1 further includes a third polarizer 50. The third polarizer 50 is disposed between the first liquid crystal cell 20 and the second liquid crystal cell 30. The third polarizer 50 and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or an angle between the axial direction of the liquid crystal molecules in the first liquid crystal cell 20 and the absorption axis of the third polarizer 50 ranges from −5 degrees to 5 degrees; and an angle between the absorption axis of the third polarizer 50 and the absorption axis of the second polarizer 40 ranges from 85 degrees to 95 degrees, such that the light leaking from the first liquid crystal cell 20 can be efficiently blocked.

In some embodiments, the liquid crystal display panel 1 further includes a fourth polarizer 60. The fourth polarizer 60 is disposed between the third polarizer 50 and the second liquid crystal cell 30. The fourth polarizer 60, the third polarizer 50, and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the forth polarizer 60, and an angle between the absorption axis of the fourth polarizer 60 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or the angle between the axial direction of the liquid crystal molecules in the first liquid crystal cell 20 and the absorption axis of the third polarizer 50 ranges from −5 degrees to 5 degrees; an angle between the absorption axis of the third polarizer 50 and the absorption axis of the forth polarizer 60 ranges from −5 degrees to 5 degrees; and an angle between the absorption axis of the fourth polarizer 60 and the absorption axis of the second polarizer 40 ranges from 85 degrees to 95 degrees, such that the light leaking from the first liquid crystal cell 20 can be efficiently blocked.

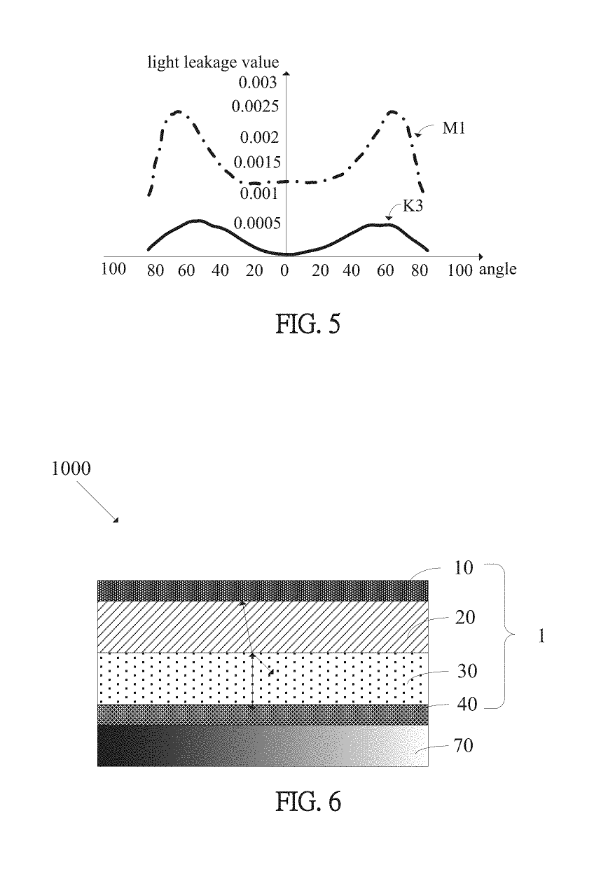

Please refer to FIG. 5, where the dash dotted line M1 shows variations of light leakage values of the conventional liquid crystal display panel, and the solid line K3 shows variations of light leakage values of the liquid crystal display panel 1 of the present embodiment. With comparison between M1 and K3, it is found that light leakage values of the liquid crystal display panel of the present embodiment are far less than light leakage values of the conventional liquid crystal display panel. Correspondingly, contrast of the liquid crystal display panel of the present embodiment is nearly 65 times higher than contrast of the conventional liquid crystal display panel.

Please refer to FIG. 6, which is a schematic diagram showing a structure of a liquid crystal display device according to one embodiment of the present disclosure. The liquid crystal display device 1000 includes a liquid crystal display panel 1 and a backlight source 2. The liquid crystal display panel 1 includes a first polarizer 10, a first liquid crystal cell 20 in an in-plane switching (IPS) mode, a second polarizer 30, and a second polarizer 40 sequentially stacked on one another.

The backlight source 2 is configured to provide source of lights for the liquid crystal display panel 1, where the emitted lights are natural lights that vibrate not just along a certain direction but along all directions. The backlight source 2 is disposed below the second polarizer 40, and is used to provide natural lights to the second polarizer 40. In the present embodiment, the backlight source 2 could be a cold cathode lamp, a light emitting diode, or an electroluminescent panel, and is not limited thereto.

The first polarizer 10 and the second polarizer 40 are disposed perpendicularly to each other, in order to have the lights vibrating along a certain direction pass therethrough while have other lights vibrating along other directions being blocked. A direction that permits the light to pass through the polarizer refers to a transmission axis of the polarizer, and a direction that blocks the light refers to an absorption axis of the polarizer.

The first liquid crystal cell 20 is an in-plane switching (IPS) liquid crystal cell. In other words, the liquid crystal molecules in the first liquid crystal cell are controlled to rotate in a plane to realize image display. The first liquid crystal cell 20 includes an upper substrate and a lower substrate. The upper substrate is a pixel electrode ITO film, and the upper substrate is a metal electrode. The liquid crystal molecules are parallel to each other and are evenly distributed between the two substrate, and are tilted with an angle with respect to the electrode of lower substrate. In the first liquid crystal cell 20 in an IPS mode, a pair of electrodes are formed on the same substrate for controlling rotation of the liquid crystal molecules. A lateral electric field generated by this pair of electrodes is used to control state of the liquid crystal molecules and makes the liquid crystal molecules twist in a plane that is parallel to the substrate. The direction of the director and the direction of the polarizer are the same, therefore the liquid crystal display panel 1 is at a dark state when there is no electric field.

At the dark state, portion of the light in the direction of the transmission axis of the liquid crystal molecules in the first liquid crystal cell 20 exists, causing light leakage. Therefore, in the present embodiment, a second liquid crystal cell 30 is disposed below the first liquid crystal cell 20, and is used to block the light leaking from the first liquid crystal cell 20 at the dark state. By reducing light leakage of the liquid crystal display panel 1 at the dark state, the dark-state brightness is lowered. This increases contrast of the liquid crystal display panel 1.

On the basis of the embodiment described above, the second liquid crystal cell 30 could be an in-plane switching (IPS) liquid crystal cell, as shown in FIG. 2. In accordance with different practical conditions, an angle between an axial direction of a plurality of liquid crystal molecules in the second liquid crystal cell 30 and an absorption axis of the second polarizer 40 can be set to be within a range to increase light leakage blocking efficiency of the second liquid crystal cell 30.

Preferably, an angle between an axial direction of a plurality of liquid crystal molecules in the second liquid crystal cell 30 and an absorption axis of the second polarizer 40 ranges from 85 degrees to 95 degrees, or the angle between the axial direction of the liquid crystal molecules in the second liquid crystal cell 30 and the absorption axis of the second polarizer 40 ranges from −5 degrees to 5 degrees, such that the light leaking from the first liquid crystal cell 20 can be efficiently blocked.

In some embodiments, the liquid crystal display panel 1 further includes a third polarizer 50. The third polarizer 50 is disposed between the first liquid crystal cell 20 and the second liquid crystal cell 30. The third polarizer 50 and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or an angle between the axial direction of the liquid crystal molecules in the first liquid crystal cell 20 and the absorption axis of the third polarizer 50 ranges from −5 degrees to 5 degrees; and an angle between the absorption axis of the third polarizer 50 and the absorption axis of the second polarizer 40 ranges from 85 degrees to 95 degrees, such that the light leaking from the first liquid crystal cell 20 can be efficiently blocked.

In some embodiments, the liquid crystal display panel 1 further includes a fourth polarizer 60. The fourth polarizer 60 is disposed between the third polarizer 50 and the second liquid crystal cell 30. The fourth polarizer 60, the third polarizer 50, and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the forth polarizer 60, and an angle between the absorption axis of the fourth polarizer 60 and the absorption axis of the second polarizer 40 can be set to be within certain ranges, such that the light leaking from the first liquid crystal cell 20 can be efficiently blocked. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from −5 degrees to 5 degrees; an angle between the absorption axis of the third polarizer 50 and the absorption axis of the forth polarizer 60 ranges from −5 degrees to 5 degrees; and an angle between the absorption axis of the fourth polarizer 60 and the absorption axis of the second polarizer 40 ranges from 85 degrees to 95 degrees, such that the light leaking from the first liquid crystal cell 20 can be efficiently blocked.

Please refer to FIG. 3, where the dash dotted line M1 shows variations of light leakage values of the conventional liquid crystal display panel, and the solid line K1 shows variations of light leakage values of the liquid crystal display panel 1 of the present embodiment. It is clear that, for the dash dotted line M1, the light leakage values of the conventional liquid crystal display panel gradually increase at the angle in the range from 0 to 60 degrees and in the range from −60 to 0 degrees, and the light leakage values of the conventional liquid crystal display panel gradually decrease at the angle in the range from 60 to 80 degrees. It is also clear that, for the solid line K1, the light leakage values of the liquid crystal display panel 1 of the present embodiment approach zero. In other words, according to the subject invention, the light leaking from the liquid crystal display panel at the dark state can be efficiently blocked. As can be further seen in FIG. 4, the solid line M2 shows variations of contrast of the conventional liquid crystal display panel, and the dash dotted line K2 shows variations of contrast of the liquid crystal display panel 1 of the present embodiment. With comparison between the lines M2 and K2, contrast of the liquid crystal display panel of the present embodiment is far higher than contrast of the conventional liquid crystal display panel. In practical operations, it is found that contrast of the liquid crystal display panel of the present embodiment is nearly 20000 times higher than contrast of the conventional liquid crystal display panel when the display is viewed at a central angle, and contrast of the liquid crystal display panel of the present embodiment is 20000-2000 times higher than contrast of the conventional liquid crystal display panel when the display is viewed at a side angle.

Furthermore, in some embodiments as shown in FIG. 2, the second liquid crystal cell 30 could be a liquid crystal cell in a vertical alignment (VA) mode, where rotation of liquid crystal molecules in the vertical direction is controlled to realize image display. The second liquid crystal cell 30 includes a liquid crystal layer, an upper substrate, and a lower substrate. The liquid crystal molecules in the second liquid crystal cell 30 are parallel to the upper and lower substrates.

In accordance with different practical conditions, an angle between an axial direction of a plurality of liquid crystal molecules in the second liquid crystal cell 30 and an absorption axis of the second polarizer 40 can be set to be within a range to increase light leakage blocking efficiency of the second liquid crystal cell 30. Preferably, an angle between an axial direction of a plurality of liquid crystal molecules in the second liquid crystal cell 30 and an absorption axis of the second polarizer 40 ranges from 40 to 50 degrees, such that the light leaking from the first liquid crystal cell 20 can be efficiently blocked.

In some embodiments, the liquid crystal display panel 1 further includes a third polarizer 50. The third polarizer 50 is disposed between the first liquid crystal cell 20 and the second liquid crystal cell 30. The third polarizer 50 and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the second polarizer 40 can be set to be within certain ranges to increase light leakage blocking efficiency. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or an angle between the axial direction of the liquid crystal molecules in the first liquid crystal cell 20 and the absorption axis of the third polarizer 50 ranges from −5 degrees to 5 degrees; and an angle between the absorption axis of the third polarizer 50 and the absorption axis of the second polarizer 40 ranges from 85 degrees to 95 degrees, such that the light leaking from the first liquid crystal cell 20 can be efficiently blocked.

In some embodiments, the liquid crystal display panel 1 further includes a fourth polarizer 60. The fourth polarizer 60 is disposed between the third polarizer 50 and the second liquid crystal cell 30. The fourth polarizer 60, the third polarizer 50, and the second liquid crystal cell 30 function collectively to block the light leaking from the first liquid crystal cell 20.

Similarly, an angle between an absorption axis of the first polarizer 10 and an absorption axis of the third polarizer 50, an angle between an axial direction of a plurality of liquid crystal molecules in the first liquid crystal cell 20 and the absorption axis of the third polarizer 50, and an angle between the absorption axis of the third polarizer 50 and the absorption axis of the forth polarizer 60, and an angle between the absorption axis of the fourth polarizer 60 and the absorption axis of the second polarizer 40 can be set to be within certain ranges, such that the light leaking from the first liquid crystal cell 20 can be efficiently blocked. Preferably, an angle between an absorption axis of the first polarizer 10 and an absorption axis of the third polarizer 50 ranges from 85 degrees to 95 degrees; an angle between an axial direction of a plurality of liquid crystal molecules in the first liquid crystal cell 20 and the absorption axis of the third polarizer 50 ranges from 85 degrees to 95 degrees, or the angle between the axial direction of the liquid crystal molecules in the first liquid crystal cell 20 and the absorption axis of the third polarizer 50 ranges from −5 degrees to 5 degrees; an angle between the absorption axis of the third polarizer 50 and the absorption axis of the forth polarizer 60 ranges from −5 degrees to 5 degrees; and an angle between the absorption axis of the fourth polarizer 60 and the absorption axis of the second polarizer 40 ranges from 85 degrees to 95 degrees, such that the light leaking from the first liquid crystal cell 20 can be efficiently blocked.

Please refer to FIG. 5, where the dash dotted line M1 shows variations of light leakage values of the conventional liquid crystal display panel, and the solid line K3 shows variations of light leakage values of the liquid crystal display panel 1 of the present embodiment. With comparison between M1 and K3, it is found that light leakage values of the liquid crystal display panel of the present embodiment are far less than light leakage values of the conventional liquid crystal display panel. Correspondingly, contrast of the liquid crystal display panel of the present embodiment is nearly 65 times higher than contrast of the conventional liquid crystal display panel.

The present disclosure provides a liquid crystal display panel and a liquid crystal display device. Since a second liquid crystal cell is disposed below the first liquid crystal cell, the light leaking from the first liquid crystal cell can be efficiently blocked at the dark state, and thus contrast is increased.

While the present disclosure has been described with the aforementioned preferred embodiments, it is preferable that the above embodiments should not be construed as limiting of the present disclosure. Anyone having ordinary skill in the art can make a variety of modifications and variations without departing from the spirit and scope of the present disclosure as defined by the following claims.

What is claimed is:

1. A liquid crystal display panel, comprising: a first polarizer, a first liquid crystal cell in an in-plane switching (IPS) mode, and a second polarizer sequentially stacked on one another;
wherein the liquid crystal display panel further comprises a second liquid crystal cell disposed between the first liquid crystal cell and the second polarizer;
wherein the first polarizer, the first liquid crystal cell, the second liquid crystal cell, and the second polarizer are configured for carrying out display of a dark state or a bright state; and
wherein, at the dark state, the second liquid crystal cell blocks a light leaking from the first liquid crystal cell.

2. The liquid crystal display panel according to claim 1, wherein the second liquid crystal cell is a liquid crystal cell in an IPS mode.

3. The liquid crystal display panel according to claim 2, wherein
an angle between an axial direction of a plurality of liquid crystal molecules in the second liquid crystal cell and an absorption axis of the second polarizer ranges from 85 degrees to 95 degrees, or the angle between the axial direction of the liquid crystal molecules in the second liquid crystal cell and the absorption axis of the second polarizer ranges from −5 degrees to 5 degrees.

4. The liquid crystal display panel according to claim 3, wherein the liquid crystal display panel further comprises a third polarizer, and the third polarizer is disposed between the first liquid crystal cell and the second liquid crystal cell.

5. The liquid crystal display panel according to claim 4, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees; and
an angle between the absorption axis of the third polarizer and the absorption axis of the second polarizer ranges from 85 degrees to 95 degrees.

6. The liquid crystal display panel according to claim 4, wherein the liquid crystal display panel further comprises a fourth polarizer, and the fourth polarizer is disposed between the third polarizer and the second liquid crystal cell.

7. The liquid crystal display panel according to claim 6, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees;
an angle between the absorption axis of the third polarizer and an absorption axis of the fourth polarizer ranges from −5 degrees to 5 degrees; and
an angle between the absorption axis of the fourth polarizer and the absorption axis of the second polarizer ranges from 85 degrees to 95 degrees.

8. The liquid crystal display panel according to claim 1, wherein the second liquid crystal cell is a liquid crystal cell in a vertical alignment (VA) mode.

9. The liquid crystal display panel according to claim 8, wherein an angle between an axial direction of a plurality of liquid crystal molecules in the second liquid crystal cell and an absorption axis of the second polarizer ranges from 40 degrees to 50 degrees.

10. The liquid crystal display panel according to claim 9, wherein the liquid crystal display panel further comprises a third polarizer, and the third polarizer is disposed between the first liquid crystal cell and the second liquid crystal cell.

11. The liquid crystal display panel according to claim 10, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees; and
an angle between the absorption axis of the third polarizer and the absorption axis of the second polarizer ranges from 85 degrees to 95 degrees.

12. The liquid crystal display panel according to claim 10, wherein the liquid crystal display panel further comprises a fourth polarizer, and the fourth polarizer is disposed between the third polarizer and the second liquid crystal cell.

13. The liquid crystal display panel according to claim 12, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees;
an angle between the absorption axis of the third polarizer and an absorption axis of the fourth polarizer ranges from −5 degrees to 5 degrees; and
an angle between the absorption axis of the fourth polarizer and the absorption axis of the second polarizer ranges from 85 degrees to 95 degrees.

14. A liquid crystal display device, comprising: a liquid crystal display panel and a backlight source;
wherein the liquid crystal display panel comprises a first polarizer, a first liquid crystal cell in an in-plane switching (IPS) mode, a second liquid crystal cell, and a second polarizer sequentially stacked on one another;
wherein a plurality of lights provided by the backlight source passes through the first polarizer, the first liquid crystal cell, the second liquid crystal cell, and the second polarizer in succession to carry out display of a dark state or a bright state; and
wherein, at the dark state, the second liquid crystal cell blocks at least one of the lights leaking from the first liquid crystal cell.

15. The liquid crystal display device according to claim 14, wherein the second liquid crystal cell is a liquid crystal cell in an IPS mode.

16. The liquid crystal display device according to claim 15, wherein
an angle between an axial direction of a plurality of liquid crystal molecules in the second liquid crystal cell and an absorption axis of the second polarizer ranges from 85 degrees to 95 degrees, or the angle between the axial direction of the liquid crystal molecules in the second liquid crystal cell and the absorption axis of the second polarizer ranges from −5 degrees to 5 degrees.

17. The liquid crystal display device according to claim 16, wherein the liquid crystal display panel further comprises a third polarizer, and the third polarizer is disposed between the first liquid crystal cell and the second liquid crystal cell.

18. The liquid crystal display device according to claim 17, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees; and
an angle between the absorption axis of the third polarizer and the absorption axis of the second polarizer ranges from 85 degrees to 95 degrees.

19. The liquid crystal display device according to claim 17, wherein the liquid crystal display panel further comprises a fourth polarizer, and the fourth polarizer is disposed between the third polarizer and the second liquid crystal cell.

20. The liquid crystal display device according to claim 19, wherein
an angle between an absorption axis of the first polarizer and an absorption axis of the third polarizer ranges from 85 degrees to 95 degrees;
an angle between an axial direction of a plurality of liquid crystal molecules in the first liquid crystal cell and the absorption axis of the third polarizer ranges from 85 degrees to 95 degrees, or the angle between the axial direction of the liquid crystal molecules in the first liquid crystal cell and the absorption axis of the third polarizer ranges from −5 degrees to 5 degrees;
an angle between the absorption axis of the third polarizer and an absorption axis of the fourth polarizer ranges from −5 degrees to 5 degrees; and
an angle between the absorption axis of the fourth polarizer and the absorption axis of the second polarizer ranges from 85 degrees to 95 degrees.
